(19) United States
(12) Patent Application Publication
(10) Pub. No.: US 2007/0221584 A1
(43) Pub. Date: Sep. 27, 2007

(54) Whole house water filter

(76) Inventor: John C. Ruprecht, North Oaks, MN (US)

Correspondence Address: JAMES D. WELCH, 10328 PINEHURST AVE., OMAHA, NE, 68124, US

(21) Appl. No.: 11/452,013

(22) Filed: Jun. 14, 2006

Related U.S. Application Data
(60) Provisional application No. 60/694,092, filed on Jun. 27, 2005.

(51) Int. Cl. C02F 1/00

(52) U.S. Cl. 210/767

(57) ABSTRACT

A floor mounted whole house water filter which does not develop significant back pressure in use because water enters via a perforated tube inlet, then flows down said perforated tube and exits radially outward through activated carbon or a ceramic filter, before exiting via an output port in an outer housing thereof.

This application Claims benefit Provisional Application Ser. No. 60/694,092 Filed Jun. 27, 2005.

### TECHNICAL FIELD

The present invention relates to filters for removing particulates from water, and more particularly to a floor mounted whole house water filter which does not develop significant back pressure because water enters via a perforated distribution tube inlet, then flows down said perforated distribution tube and exits radially outward through activated carbon or a ceramic filter, before exiting via an output means in an outer housing thereof.

### BACKGROUND

It is know to use filters to remove particulates from water. A problem with many such filters, however, is that they cause significant back pressure to develop, and where a filter is to be applied to filter water which enters a house it is important that back pressure not develop, as back pressure reduces in-house water pressure. The present invention is a filter system which does not develop significant back pressure in use.

With the present invention in mind, a Search of patents was conducted and identified:
Published Application US 2004/0154976 and U.S. Pat. No. 6,827,852 to Fuentes discloses a filter housing assembly containing a filter bag;
U.S. Pat. No. 5,910,247 to Outterside describes a two element filter bag, a cylinder outer element and tubular inner element. It is not of a single bag filter or single ceramic filter design, with in flow and out flow being through activated carbon, and there are tubular inner elements present, as that terminology is used in said 247 patent;
U.S. Pat. No. 5,624,559 to Levin et al. describes a bag filter and retainer therefore;
U.S. Pat. No. 5,591,338 to Pruette et al. describes a fluid filter with tubular core surrounded by wire cage around which is a pleated bag, and is not of an all-resin construction;
U.S. Pat. No. 4,913,815 to Shulda describes a concentric dual bag filter with contained media. The Dual bag filter apparatus has an inlet, outlet, outer and inner bag, filter medium within the outer bag and a perforated tube in the inner bag. The 815 system has multiple bags, and does not have a filter held in place by a reusable slotted colander, and does not have a filter housing made of resin with a fitted slotted colander, which is also made of resin;
U.S. Pat. No. 5,514,275 Wall filter unit with filter bag supported within a chamber. The present invention is a floor mounted unit as its size and filtering capability precludes it from being wall mounted;
U.S. Pat. No. 5,006,245 describes a water purifying device with an outer and inner cylinder filled with water purifying material. However, the major components are not made from resin with no metal in either the inner or outer cylinders;
U.S. Pat. No. 5,376,271 to Morgan, Jr. describes a liquid filtration unit with a filter basket containing a filter bag;
U.S. Pat. No. 4,652,369 to DePolo et al. describes a filtering system for swimming pools and has cylinder a porous filter bag with a center tube.

Even in view of the identified patents, need remains for improved filter systems which do not develop significant back pressure thereby reducing in-house water pressure.

### DISCLOSURE OF THE INVENTION

To begin, it is noted that because of its design, the floor mounted whole house water filter of the presently disclosed invention does not develop significant back pressure to water entered thereinto. This is because water flow is completely or at least predominately outward through filtering means, from a small area toward a large area. To achieve this result, the present invention system can comprise a housing with an inner colander that is slotted, and have a bag filter which contains filler material, or a ceramic filter, fitted into said slotted inner colander. A perforated tube that is capped on the bottom end is centered in the bag filter, and activated carbon is caused to be present in said bag filter with the centered perforated tube positioned in the center thereof. Said perforated tube serves to distribute water input thereto into the filter activated carbon along the length thereof. With a bag filter full of activated carbon or a ceramic filter in place, a top cap with centering tube is placed over the slotted colander and the center tube top cap is then secured thereto. The slotted colander is lowered into the filter housing, and the filter element seals against an “O”-ring that is present around the outside of slotted colander in a groove designed therefore. The “O”-ring is located near the top of the colander and seals the colander/filter element against the filter housing to prevent water migration around the filter element to the discharge. Water enters the top of the filter element via the perforated tube, and said inlet water flows down the perforated tube, and exits therefrom radially outward through the activated carbon, then out of the bag filter through the slotted colander to discharge of the filter outer housing. As mentioned, this design results in next to no water pressure drop through the described filter, utilization of the entire carbon bed, and easy change out of the filter element when required. The user then, never comes in contact with the captured hazardous waste.

The present invention system can also comprise an embodiment which is very similar to that just described above, but instead of having a bag filter, has a ceramic filter having, for instance, a 99.99% efficiency at 0.9-microns. Note that said ceramic filter has been third party tested to remove E. Coli and is efficient at removing particulates to 0.4 microns at 99.6%. Said ceramic filter has, for instance, 0.05% silver embedded in the ceramic, and the silver prevents captured bacteria from breeding or growing therein and is a self sanitizing agent. It is disclosed that testing of the present invention was performed on Apr. 22, 2005 by Analytical Food Laboratories, 856 Greenview Drive, Grand Prairie, Tex. Said Testing facility certified that the present invention Ceramic water filter element was tested for bacteriological removal capacity and showed greater than 99.99% removal efficiency at 0.9 microns. The test method consists of growing cultures of E. coli then diluting them into tap water to give the concentration required for test. Normally, a concentration between 10 to the 4 and 10 to the 5 colony forming units (CFU) per ml are used as the influent water level to the filter, and the removal efficiency is tested at a flow rate of 300 liters per hour and 90 liters per hour, using separate filters or sterilizing between tests. Preferably sterilization is done prior to the test as well. The level of E. Coli in the influent and effluent water is measured on each test run. The challenge water was inoculated with live culture of E. Coli (generic) of a known concentration. The water was then filtered through the provided apparatus and samples were taken at the beginning, middle and end. Typical growth was recovered in the filtered water but at lower levels indicating the filter was able to block passage of the specific bacteria. The data provided is:
Initial Concentration: 5.7×10⁸ Inoculum was diluted to 30,000 cfu/mL and placed in the apparatus. From the apparatus, aseptic samples were pulled at the beginning of the filtering, middle of the filtering and end of the filtering. The samples were then tested using methods from BAM Ch4.
Recovery of the bacteria at levels of 0.6% or a filtering percentage of 99.4% indicates that the filter provided blockage of the bacteria.

Continuing, the ceramic filter is cast to fit inside the slotted colander, the top of the ceramic filter is sealed to the slotted colander preventing non-filtered water migrating around the ceramic filter to discharge. The cast ceramic filter is fitted into the slotted colander a perforated tube that is capped on the bottom end is then centered in the ceramic filter, activated carbon is caused to be present in the ceramic filter with the centered perforated tube positioned in the center. With the ceramic filter full of activated carbon a top cap with centering tube is placed over the slotted colander and center tube this top cap is then secured to the slotted colander. The slotted colander is lowered into the filter housing placing the filter element against a sealing “O”-ring that is installed around the outside of slotted colander in a groove designed to receive the “O”-ring, which is located near the top of the colander. This seals the colander/filter element against the filter housing and prevents water migration around the filter element to discharge. Water enters the top of the filter element via the perforated tube inlet water flows down the perforated tube and exits radially outward, proceeds through the activated carbon and ceramic filter, then through the slotted colander to discharge of the filter housing. This design results in next to no water pressure drop through the present invention filter, and utilization of a single element carbon bed and ceramic filter enables easy change out of the filter element when required. Further, as mentioned, the user never comes in contact with the captured hazardous waste.

Re-itterating, the present invention floor mounted whole house water filter comprises an outer cylinder having input and output means present thereon for entering and exiting water. Said outer cylinder is closed on the bottom and sides, and has means for securing a top thereto. There is further present a perforated input tube which functionally attaches to said input means of said outer cylinder. A bag or ceramic filter, into which said perforated input tube centrally projects, is substantially filled with filler material, and a perforated inner cylinder surrounds said bag or ceramic filter. In use a top is secured to said outer cylinder via water sealing means such as an “O” ring, and water is entered to said input means. Said water passes through said perforated input tube, through said bag or ceramic filter and filler material therein, and through said perforated inner cylinder before exiting through said output means in said outer cylinder.

The present invention then comprises a floor mounted whole house water filter which does not develop significant back pressure to water entered thereinto, comprising:

an outer cylinder having input and output ports present thereon for entering and exiting water, said outer cylinder being substantially closed on the bottom and sides, and having means for securing a top thereto;
a top;
a perforated input tube functionally continuous with said input port of said outer cylinder;
a bag containing filler material or ceramic filter into which said perforated input tube centrally projects; and
a perforated cylinder which surrounds said bag or ceramic filter;
such that in use said top is secured to said outer cylinder and water is entered to said input port, then passes through said perforated tube, outwardly through said bag or ceramic filter and said perforated cylinder, before exiting through said output port in said outer cylinder.
The bag or ceramic filter is preferably an easily changed one piece system, and where a ceramic filter is used it can have silver embedded in the ceramic, the purpose thereof being to prevent captured bacteria from breeding or growing therein as a self sanitizing agent.

The floor mounted whole house water filter can be distinguished in that present between said input port and said perforated tube is present a pre-filter oriented such that water entered into said input port passes therethrough inwardly toward said perforated tube. The perforated tube can extend into a central hole in the pre-filter or said pre-filter can be a solid disk shape with the open top of the perforated tube projecting only part way into said disk, or being present therebelow. Further, said pre-filter can be of any functional construction, such as a wound 5 micron or 2 micron filter element, may be of a pleated construction, or may comprise beads and/or other media present in a canister. Said pre-filter can be fashioned to remove specific contaminates, such as arsenic or mercury etc. The contents of a canister can be tailored to specific needs of those using it.

A method of removing particulate and other matter from water comprises the steps of:

a) providing floor mounted whole house water filter which does not develop significant back pressure to water entered thereinto, comprising:
an outer cylinder having input and output port present thereon for entering an exiting water, said outer cylinder being substantially closed on the bottom and sides, and having means for securing a top thereto;
a top;
a perforated tube functionally continuous with said input port of said outer cylinder;
a bag filled with filler material or ceramic filter into which said perforated input tube centrally project; and
a perforated cylinder which surrounds said bag or ceramic filter;
such that in use said top is secured to said outer cylinder and water is entered to said input port, then passes outwardly through said perforated tube, then through said bag or ceramic filter and said perforated cylinder before exiting through said output port in said outer cylinder;

b) connecting said input port of said floor mounted whole house filter to a source of water, and connecting said output port to the water input system of a house or the like;

such that in use water containing particulate and other matter is caused to flow through said floor mounted whole house filter such that said particulate and other matter is substantially removed, followed by said water with the particulate and other matter substantially removed entering said house.

### The step of providing a bag containing filler material or ceramic filter containing filler material comprises providing a one piece system.

### Said method can further comprise providing, between said input port and said perforated tube, a pre-filter oriented such that water entered into said input port passes therethrough inwardly toward said perforated tube.

Said method can further comprise the step of removing said top from said outer cylinder, easily removing said bag containing filler material or ceramic filter one piece system, and replacing it with another one piece bag containing filler material or ceramic filter system, followed by re-securing the top to the outer cylinder.

The present invention will be better understood by a reading of the Detailed description Section of this Disclosure with reference to the Drawings.

### BRIEF DESCRIPTION OF THE DRAWINGS

FIG. 1a shows an elevational cross-sectional view of a basic version of the present invention whole house water filter.

FIGS. 1b and 1c show elevational cross-sectional views of a version of the present invention whole house water filter including a Pre-Filter.

FIG. 2a shows generally a Bag or Ceramic Filter for application in the present invention whole house water filter.

FIGS. 2b and 2c show a Pre-Filter for application in the present invention whole house water filter.

FIG. 3 shows a partially assembled side elevational view of the exterior of the presently disclosed invention system.

FIG. 4 shows an assembled view of the exterior of the presently disclosed invention system.

FIG. 5 is a cross-sectional taken at b-b in FIG. 4, and shows a Perforated Input Tube projects into a Bag filled with a filler material or Ceramic Filter, said bag or ceramic filter being secured within a Perforated Cylinder.

### DETAILED DESCRIPTION

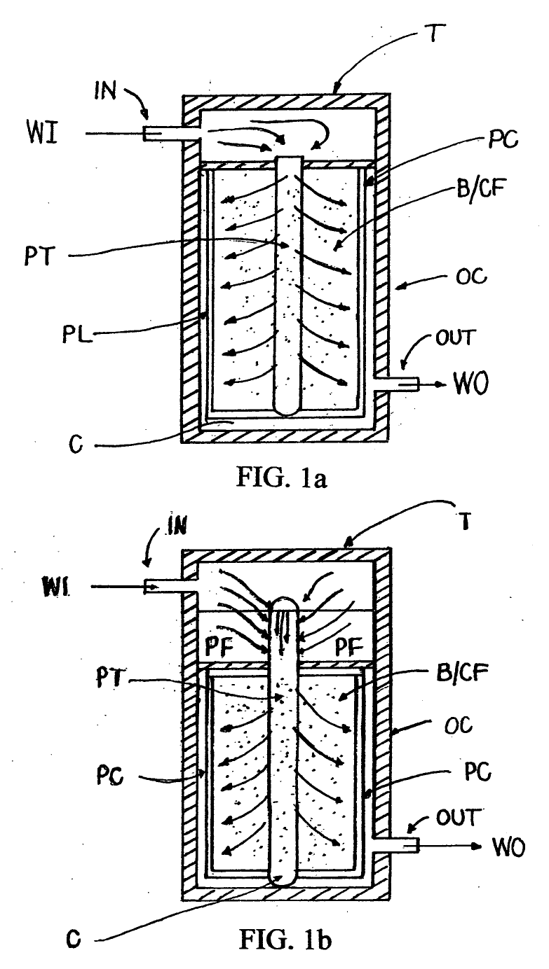

Turning now to the Drawings, FIGS. 1a and 1b show elevational cross-sectional views of a basic and augmented versions of the present invention whole house water filter. Shown are an Outer Cylinder (OC) having Inlet (IN) and Outlet (OUT) ports for entering (WI) and exiting (WO) water. In said Outer Cylinder (OC) is an Perforated Cylinder (PC) which surrounds and holds in place a Bag or Ceramic Filter (B/CF). When a Bag is used it is filled with a Filter material (FM) such as activated charcoal. Located substantially centrally in said Bag or Ceramic Filter (B/CF) is a Perforated Tube (PT). FIG. 1b shows an elevational cross-sectional view of a version of the present invention whole house water filter including a Pre-Filter (PF), but which is otherwise similar to what is shown in FIG. 1a. It is noted that while FIG. 1b shows the Perforated tube (PT) extending through a hole in the center of the Pre-filter (PF), it is within the scope of the present invention to provide that the Pre-filter (PF) be of a disc shape with the Perforated Tube (PT) extending only partially thereinto, or not at all. That is an open top of a Perforated Tube (PT) can be present below a Pre-filter (PF) without a central hole present therein.

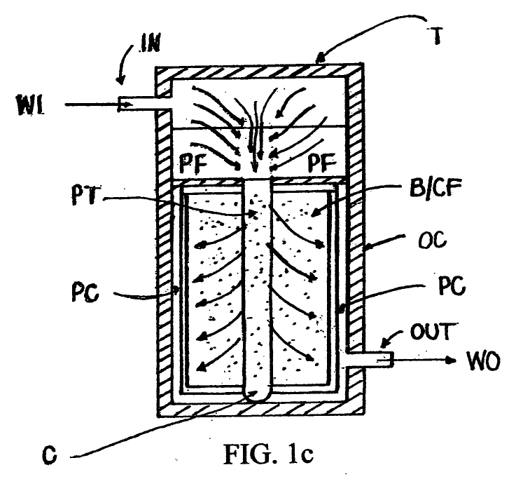

FIG. 2a shows generally a Bag or Ceramic Filter (B/CF) for application in the present invention whole house water filter, and FIG. 2b shows the generally a Pre-Filter (PF) for application in the present invention whole house water filter as shown in FIG. 1b.

As regards FIG. 1a, in use water (WI) is flowed into port (IN), enters the Perforated Tube (PT) and flows outward through the Bag or Ceramic Filter (B/CF), including a Filter Material (FM) present therein, and then flows through Perforated Cylinder (PC) and out of Port (OUT) as water flow (WO). As regards FIG. 1b, the Pre-Filter (PF) is applied to receive water (WI) which is flowed into port (IN). Said water (WI) flows through said Pre-Filter (PF) centrally into said Perforated Tube (PT), and then continues to flow as described with respect to FIG. 1a. Note that the bottom of the Perforated Tube (PT) is fitted with a termination Cap (C).

NOTE, while in FIG. 1b some initial water flow is directed inwardly toward the Perforated Tube (PT), the majority of water flow in both the FIGS. 1a and 1b systems is outward. That is from a small area toward a large area. This approach minimizes the development of back-pressure, which is undesirable in filters which provide water to a house as it reduces water pressure in said house.

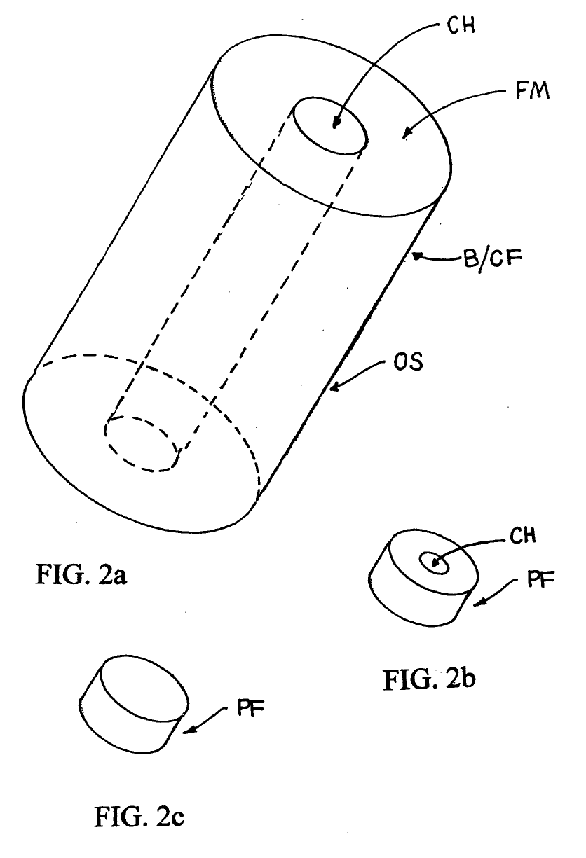

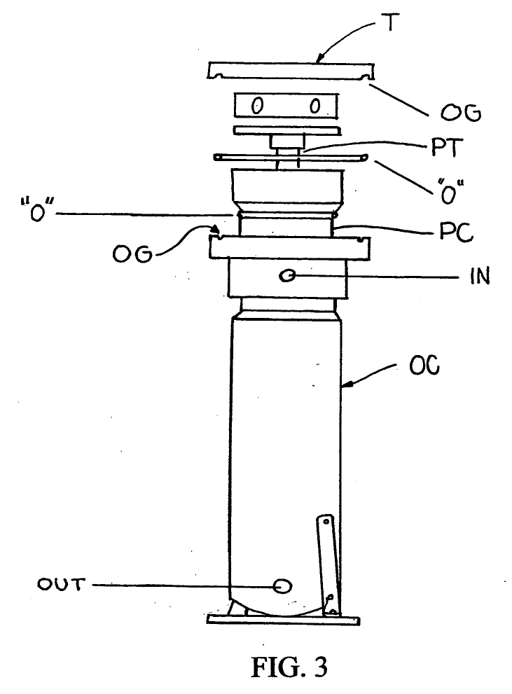

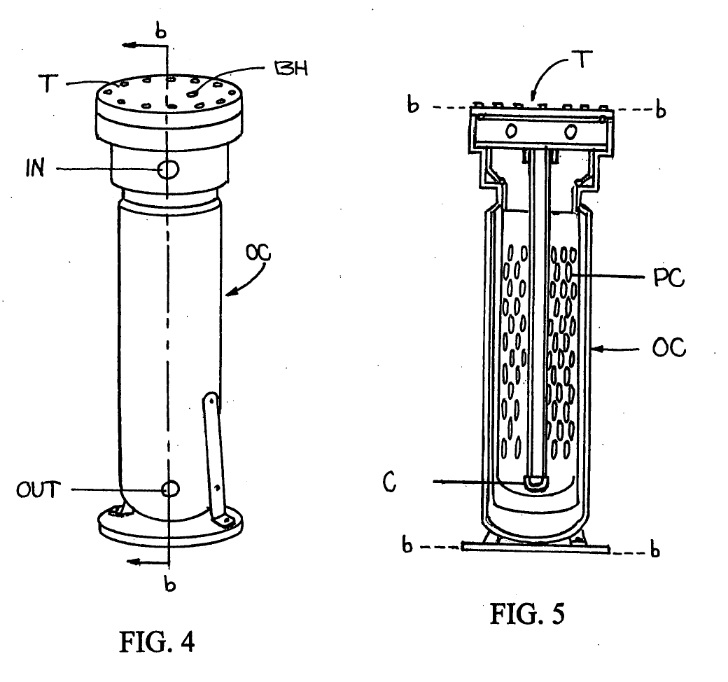

FIG. 3 shows a partially assembled side elevational view of the a realization of a presently disclosed invention system, and FIG. 4 shows an assembled view of the exterior of the presently disclosed invention whole house water filter system. Shown are the Outer Cylinder (OC) and a Top (T) at the upper portion thereof, a portion of a Perforated Tube (PT), In the Outer Cylinder are shown the Input (IN) and Output (OUT) Ports. In use, the Perforated Input Tube projects into a Bag or Ceramic Filter (B/CF) which is secured within an Inner Cylinder by a Perforated Cylinder (PC). Further, an “O” ring, or functional equivalent, is sandwiched between said Top and the top of the Outer Cylinder in “O” Ring Grooves (OG). When the Top is secured in place, an input of the Perforated Input Tube is positioned to receive water from the Inlet Port (IN) of the Outer Cylinder (OC). In operation, water is entered to the Inlet Port (IN), and passes through the Perforated Input Tube (PT), through the Filler Material and Bag or Ceramic Filter (B/CF), then through the Perforated Cylinder (PC), and out of the Outlet Port (OUT). The Bag and Filler Material therein, or Ceramic Filter (B/CF) serves to trap particulate and other matter input to the Whole House Filter. FIG. 2a shows the general shape of a Bag or Ceramic Filter (B/CF), including indication of a Central Hole (CH) into which a Perforated Tube (PT) is inserted. Note that another feature of a preferred embodiment is that the Bag and Filler Material or Ceramic Filter (B/CF) is sequestered in an easily changed one piece system. The active portion of said Bag and Filler Material or Ceramic. Filter (B/CF) is caused to be present in the annular space between the Central Hole (CH) and the Outer Surface (OS) thereof. This makes changing Filler Material (FM) or Ceramic, when it is spent, a very easy task. FIG. 2b generally shows a Pre-Filter (PF), which is typically of a pleated construction.

FIGS. 2c and 1c show a variation of FIGS. 2b and 1b wherein the Pre-Filter (PF) does not have a Central Hole. This is within the scope of the invention.

Having hereby disclosed the subject matter 6f the present invention, it should be obvious that many modifications, substitutions, and variations of the present invention are possible in view of the teachings. It is therefore to be understood that the invention may be practiced other than as specifically described, and should be limited in its breadth and scope only by the Claims.

1. A water filter which does not develop significant back pressure to water entered thereinto, comprising:
an outer cylinder having input and output ports present thereon for entering and exiting water, said outer cylinder being substantially closed on the bottom and sides, and having means for securing a top thereto;
a top;
a perforated input tube functionally continuous with said input port of said outer cylinder;
a bag containing filler material or ceramic filter into which said perforated input tube centrally projects; and
a perforated cylinder which surrounds said bag or ceramic filter;
such that in use said top is secured to said outer cylinder and water is entered to said input port, then passes through said perforated tube, outwardly through said bag or ceramic filter and said perforated cylinder, before exiting through said output port in said outer cylinder.

2. A water filter as in claim 1, wherein the said bag or ceramic filter in an easily changed one piece system.

3. A water filter as in claim 1, which comprises a ceramic filter having silver embedded in the ceramic, the purpose thereof being to prevent captured bacteria from breeding or growing therein as a self sanitizing agent.

4. A method of removing particulate and other matter from water comprising the steps of:
a) providing a water filter which does not develop significant back pressure to water entered thereinto, comprising:
an outer cylinder having input and output port present thereon for entering an exiting water, said outer cylinder being substantially closed on the bottom and sides, and having means for securing a top thereto;
a top;
a perforated tube functionally continuous with said input port of said outer cylinder;
a bag filled with filler material or ceramic filter into which said perforated input tube centrally project; and
a perforated cylinder which surrounds said bag or ceramic filter;
such that in use said top is secured to said outer cylinder and water is entered to said input port, then passes outwardly through said perforated tube, then through said bag or ceramic filter and said perforated cylinder before exiting through said output port in said outer cylinder;
b) connecting said input port of said water filter to a source of water, and connecting said output port to the water input system of a house or the like;
such that in use water containing particulate and other matter is caused to flow through said water filter such that said particulate and other matter is substantially removed, followed by said water with the particulate and other matter substantially removed entering said house.

5. A method as in claim 4, wherein the step of providing a bag containing filler material or ceramic filter containing filler material comprises providing a one piece system.

6. A method as in claim 5 which further comprises the step of removing said top from said outer cylinder, easily removing said bag containing filler material or ceramic filter one piece system, and replacing it with another one piece bag containing filler material or ceramic filter system, followed by re-securing the top to the outer cylinder.

7. A water filter which does not develop significant back pressure to water entered thereinto, comprising:
an outer cylinder having input and output port present thereon for entering and exiting water, said outer cylinder being substantially closed on the bottom and sides, and having means for securing a top thereto;
a top;
a perforated input tube functionally continuous with said input port of said outer cylinder;
a bag containing filler material or ceramic filter into which said perforated input tube centrally projects; and
a perforated cylinder which surrounds said bag or ceramic filter;
such that in use said top is secured to said outer cylinder and water is entered to said input port, then passes outwardly through said perforated tube, through said bag or ceramic filter, and said perforated cylinder, before exiting through said output port in said outer cylinder;
said water filter being distinguished in that present between said input port and said perforated tube is present a pre-filter oriented such that water entered into said input port passes therethrough inwardly toward said perforated tube.

8. A water filter as in claim 7, wherein the said bag or ceramic filter in an easily changed one piece system.

9. A water filter as in claim 7, which comprises a ceramic filter having silver embedded in the ceramic, the purpose thereof being to prevent captured bacteria from breeding or growing therein as a self sanitizing agent.

10. A method of removing particulate and other matter from water comprising the steps of:
a) providing a water filter which does not develop significant back pressure to water entered thereinto, comprising:
an outer cylinder having input and output port present thereon for entering an exiting water, said outer cylinder being substantially closed on the bottom and sides, and having means for securing a top thereto;
a top;
a perforated tube functionally continuous with said input port of said outer cylinder;
a bag filled with filler material or ceramic filter into which said perforated input tube centrally project; and
a perforated cylinder which surrounds said bag or ceramic filter;
such that in use said top is secured to said outer cylinder and water is entered to said input port, then passes outwardly through said perforated tube, then through said bag or ceramic filter and said perforated cylinder before exiting through said output port in said outer cylinder;
said water filter being distinguished in that present between said input port and said perforated tube is present a pre-filter oriented such that water entered into said input port passes therethrough inwardly toward said perforated tube;
b) connecting said input port of said water filter to a source of water, and connecting said output port to the water input system of a house or the like;
such that in use water containing particulate and other matter is caused to flow through said water filter such that said particulate and other matter is substantially removed, followed by said water with the particulate and other matter substantially removed entering said house.

11. A method as in claim 10, wherein the step of providing a bag containing filler material or ceramic filter containing filler material comprises providing a one piece system.

12. A method as in claim 11 which further comprises the step of removing said top from said outer cylinder, easily removing said bag containing filler material or ceramic filter one piece system, and replacing it with another one piece bag containing filler material or ceramic filter system, followed by re-securing the top to the outer cylinder.

13. A water filter as in claim 1 which is floor mounted.

14. A water filter as in claim 1 which is applied to process water entered to a whole house.

15. A method as in claim 4 wherein the step of providing a water filter involves mounting it to a floor.

16. A method as in claim 4 wherein said water filter is applied to process water entered to a whole house.

17. A water filter as in claim 7 which is floor mounted.

18. A water filter as in claim 7 which is applied to process water entered to a whole house.

19. A method as in claim 10 wherein the step of providing a water filter involves mounting it to a floor.

20. A method as in claim 10 wherein said water filter is applied to process water entered to a whole house.
